(19) United States
(12) Patent Application Publication
(10) Pub. No.: US 2013/0151150 A1
(43) Pub. Date: Jun. 13, 2013

(54) ELECTRONIC DEVICE WITH TRIP PLANNING FUNCTION AND TRIP PLANNING METHOD

(71) Applicants: Ying-Chuan YU, Tu-Cheng (TW); Ying-Xiong HUANG, Tu-Cheng (TW)

(72) Inventors: Ying-Chuan YU, Tu-Cheng (TW); Ying-Xiong HUANG, Tu-Cheng (TW)

(73) Assignee: HON HAI PRECISION INDUSTRY CO., LTD., Tu-Cheng (TW)

(21) Appl. No.: 13/459,100

(22) Filed: Apr. 28, 2012

(30) Foreign Application Priority Data
Dec. 13, 2011 (TW) 100145900

(51) Int. Cl. G01C 21/00

(52) U.S. Cl. 701/537

(57) ABSTRACT

A trip planning method implemented by an electronic device includes receiving a first trip planning request via an input unit from a user; sending the first trip planning request to a server to obtain the first trip plan corresponding to the first trip planning request from the server after determining that the first trip plan does not already exist in a memory, and saving the first trip plan to the memory after obtaining the first trip plan from the server; receiving a second trip planning request from the user; determining whether the second trip plan needs to be generated; and generating the second trip plan corresponding to the second trip planning request by updating the first trip plan according to the second trip planning request after determining that the second trip plan needs to be generated. The electronic device is also provided.

### BACKGROUND

1. Technical Field

The present disclosure relates to electronic devices with trip planning function and trip planning methods, and more particularly, to an electronic device with trip planning function and a trip planning method for reading and updating a trip plan without network connection.

2. Description of Related Art

People often search information related to trip destinations such as positions, traffic routes for trip planning and then store the trip plan over a network. However, the trip plan often needs to be changed because of some factors such as weather, if the saved trip plan is inconvenient to obtain though a network, change of the trip plan, for example, reducing five destinations to three, will be hard to made to the saved trip plan.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of a system with trip planning function, in accordance with the present disclosure.

FIG. 2 is a flowchart of an embodiment of saving a first trip plan corresponding to a first trip planning request implemented by the system of FIG. 1, in accordance with the present disclosure.

FIG. 3 is a flowchart of an embodiment of updating a first trip plan implemented by the system of FIG. 1, in accordance with the present disclosure.

### DETAILED DESCRIPTION

Embodiments of the present disclosure will be described with reference to the accompanying drawings.

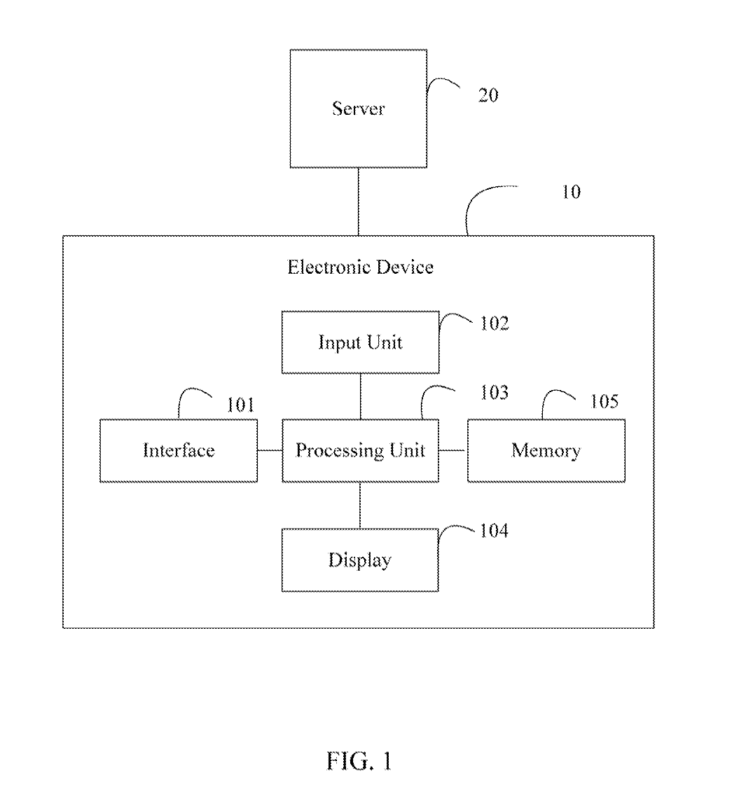

FIG. 1 is a block diagram of an embodiment of a system with trip planning functions, in accordance with the present disclosure. Trip planning means planning all information related with destinations to be searched, including positions, and associated traffic routes, for example. Trip plan means a result of the trip planning. The system includes an electronic device 10 and a server 20 connected via network. The electronic device 10 may be desktop computers, STB (Set Top Box), phone or tablet computer.

The server 20 saves a database containing relevant parameters of GIS (geographic information system) and a search software to provide network support. The server 20 receives a first trip planning request, searches the database to generate a first trip plan corresponding to the first trip planning request, and then sends the first trip plan to the electronic device 10 via the network connection. The first trip planning request may be a request to mark or annotate positions of a first destination and/or a first associated travel route of the first destination. The first trip plan includes the map with markings of the position of the first destination and the first associated travel route of the first destination, and/or annotations of the position of the first destination and associated travel route of the first destination corresponding to the first trip planning request.

The electronic device 10 includes an interface 101, an input unit 102, a processing unit 103, a display 104, and a memory 105.

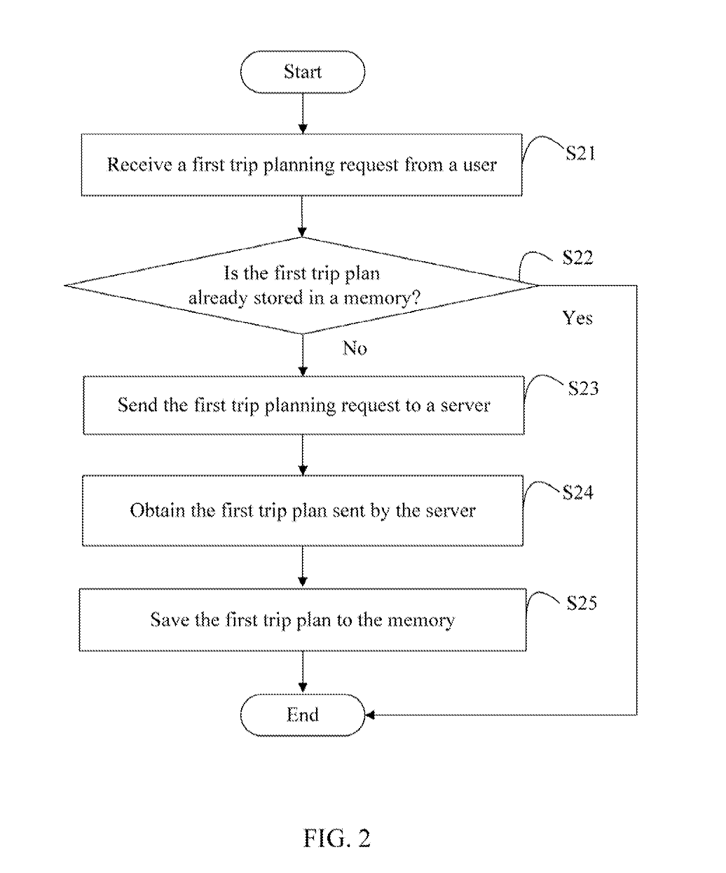

The interface 101 provides network connection to receive information from the server 20. The input unit 102 receives user input. The display 103 is used to display a number of multimedia files. The memory 105 supplies space to store data. The functions of the processing unit 103 will be described together with FIG. 2.

FIG. 2 is a flowchart of an embodiment of saving first trip plan corresponding to the first trip planning request implemented by the system of FIG. 1, in accordance with the present disclosure. Before saving the first trip plan corresponding to the first trip planning request, the electronic device 10 is connected with the server 20 via the interface unit 101.

In step S21, the processing unit 103 receives the first trip planning request via the input unit 102 from the user.

In step S22, the processing unit 103 determines whether the first trip plan corresponding to the first trip planning request is already stored in the memory 105. If yes, the procedure ends, if not, the procedure goes to step S23.

In step S23, the processing unit 103 sends the first trip planning request to the server 20. The server 20 searches the database according to the first trip planning request to generate the first trip plan corresponding to the first trip planning request by the search software.

In step S24, the processing unit 103 obtains the first trip plan corresponding to the first trip planning request sent by the server 20.

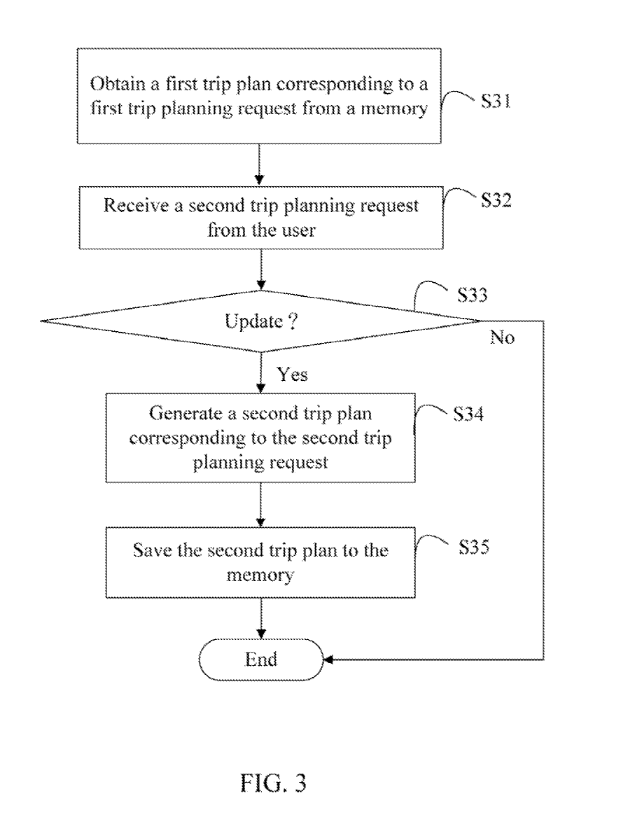

In step S25, the processing unit 103 saves the first trip plan corresponding to the first trip planning request to the memory 105, then the procedure goes to step S31 of FIG. 3.

FIG. 3 is a flowchart of an embodiment of updating the first trip plan of FIG. 2 implemented by the system of FIG. 1, in accordance with the present disclosure. In the procedure of FIG. 3, the electronic device 10 does not need to be connected with the server 20.

In step S31, the processing unit 103 obtains the first trip plan corresponding to the first trip planning request from the memory 105.

In step S32, the processing unit 103 receives a second trip planning request from the user. The second trip planning request includes a request to update the first destination and/or the first associated travel route of the first destination in the first trip plan.

In step S33, the processing unit 103 determines whether a second trip plan needs to be generated by updating the first trip plan, if yes, the procedure goes to step S34, if no, the procedure ends.

In a preferred embodiment, the second trip planning request includes a second destination, and the processing unit determines whether a second trip plan needs to be generated by updating the first trip plan by determining whether the second destination in the second trip planning request is in proximity of the first destination in the first trip plan, if the second destination in the second trip planning request is in proximity of the first destination in the first trip plan, the second trip plan does not need to be generated, and if the second destination in the second trip planning request is not in proximity of the first destination in the first trip plan, the second trip plan needs to be generated.

In step S34, the processing unit 103 generates the second trip plan corresponding to the second trip planning request by updating the first trip plan according to the second trip planning request.

In step S35, the processing unit 103 saves the second trip plan to the memory 105.

In other embodiments, after saving the second trip plan to the memory 105, the processing unit 103 deletes the first trip plan.

Though the method above, the user obtains the first trip plan according to the first trip planning request via network connection and saves the first trip plan to the memory 105. The trip plan can be re-read and updated to generate the second trip plan corresponding to the second trip planning request without the network connection, which is easier for user.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An electronic device with trip planning function, comprising:
an interface, to provide network connection to receive information from a server;
an input unit;
a memory; and
a processing unit, wherein the processing unit performs:
receiving a first trip planning request via the input unit from a user;
sending the first trip planning request to the server to obtain a first trip plan corresponding to the first trip planning request from the server after determining that the first trip plan does not already exist in the memory, and saving the first trip plan to the memory after obtaining the first trip plan from the server;
receiving a second trip planning request from the user;
determining whether the second trip plan needs to be generated; and
generating the second trip plan corresponding to the second trip planning request by updating the first trip plan according to the second trip planning request after determining that the second trip plan needs to be generated,
wherein the second trip planning request comprises a request to update a first destination and/or a first associated travel route of the destination in the first trip plan.

2. The electronic device of claim 1, wherein the second trip planning request comprises a second destination, and the processing unit determines whether the second trip plan needs to be generated by determining whether the second destination in the second trip planning request is in proximity of the first destination in the first trip plan, if the second destination in the second trip planning request is in proximity of the first destination in the first trip plan, the second trip plan does not need to be generated, and if the second destination in the second trip planning request is not in proximity of the first destination in the first trip plan, the second trip plan needs to be generated.

3. The electronic device of claim 1, wherein the processing unit saves the second trip plan according to the second trip planning request to the memory.

4. The electronic device of claim 3, wherein the processing unit deletes the first trip plan after saving the second trip plan to the memory.

5. A trip planning method implemented by an electronic device, comprising:
receiving a first trip planning request via an input unit from a user;
sending the first trip planning request to a server to obtain the first trip plan corresponding to the first trip planning request from the server after determining that the first trip plan does not already exist in a memory, and saving the first trip plan to the memory after obtaining the first trip plan from the server;
receiving a second trip planning request from the user;
determining whether the second trip plan needs to be generated; and
generating the second trip plan corresponding to the second trip planning request by updating the first trip plan according to the second trip planning request after determining that the second trip plan needs to be generated,
wherein the second trip planning request comprises a request to update a first destination and/or a first associated travel route of the destination in the first trip plan.

6. The trip planning method of claim 5, wherein the second trip planning request comprises a second destination, and the method of determining whether the second trip plan needs to be generated further comprises determining whether the second destination in the second trip planning request is in proximity of the first destination in the first trip plan, if the second destination in the second trip planning request is in proximity of the first destination in the first trip plan, the second trip plan does not need to be generated, and if the second destination in the second trip planning request is not in proximity of the first destination in the first trip plan, the second trip plan needs to be generated

7. The trip planning method of claim 5, further comprising saving the second trip plan to the memory.

8. The trip planning method of claim 7, further comprising deleting the first trip plan after saving the second trip plan to the memory.
